(19) United States
(12) Patent Application Publication
(10) Pub. No.: US 2026/0287457 A1
(43) Pub. Date: Sep. 24, 2026

(54) METHOD AND SYSTEM FOR DIAGNOSING LEAKAGE OF INSULATING OIL

(71) Applicant: Fortune Electric Co., Ltd., Taoyuan City (TW)

(72) Inventors: CHIA-CHING LIN, Taoyuan City (TW); CHING-MIN CHEN, Taoyuan City (TW); YA-HUA LEE, Taoyuan City (TW)

(21) Appl. No.: 19/292,867

(22) Filed: Aug. 6, 2025

(30) Foreign Application Priority Data
Mar. 20, 2025 (TW) 114110406

(51) Int. Cl. G01M 3/00; G08B 21/18; H01F 27/12; H01F 27/32

(52) U.S. Cl. CPC G01M 3/002; G08B 21/182; H01F 27/12; H01F 27/32

(57) ABSTRACT

A method and a system for diagnosing leakage of an insulating oil. The method and the system pre-warn an oil leakage anomaly in a transformer. The transformer includes an oil storage tank and the insulating oil contained in the oil storage tank. The system includes an inspection device and a diagnosis device. The inspection device includes a sensing module and a processing module connected to the sensing module. The sensing module is disposed on the oil storage tank to obtain state information of the insulating oil within at least one unit time interval. The processing module establishes a conversion function relationship between an oil temperature and an oil level of the insulating oil based on the state information. The diagnosis device is connected to the processing module, and performs an early leakage warning of the insulating oil according to the conversion function relationship during operation of the transformer.

### CROSS-REFERENCE TO RELATED PATENT APPLICATION

This application claims the benefit of priority to Taiwan Patent Application No. 114110406, filed on Mar. 20, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology for diagnosing an oil leakage anomaly, and more particularly to a method and a system for diagnosing leakage of an insulating oil of a transformer.

### BACKGROUND OF THE DISCLOSURE

An oil-immersed transformer is a common electrical apparatus, which is used for decreasing a high voltage to a low voltage or increasing a low voltage to a high voltage. Whether or not such transformers can operate stably is directly related to the reliability of the power supply from an electrical grid. The main feature of the oil-immersed transformer is immersion of a ferrite core and windings in an insulating oil. In this way, insulation performance of a transformer can be enhanced, such that malfunctioning of electrical appliances and fire hazards can be prevented. Furthermore, the insulating oil can effectively dissipate heat, so as to enable the transformer to have a relatively stable temperature, and improve an operational efficiency and a service life of the transformer.

In general, when a load of the transformer is increased, a temperature of the insulating oil is increased, and an oil level is also raised due to volume expansion. Conversely, when the load of the transformer is decreased, the temperature of the insulating oil is decreased, and the oil level is also lowered due to volume shrinkage. Hence, changes in the oil level can reflect a health state of the transformer. If the oil level is too high or too low, an anomaly is likely to have occurred in an interior of the transformer, which may lead to malfunctioning of the transformer or even accidents. For example, when the oil level is too high, pressure inside an oil tank will be so increased as to cause oil leakage. When the oil level is too low, the insulation performance of the transformer will be decreased, thereby resulting in insulation breakdown.

Therefore, an oil level gauge is disposed in an oil storage device of the transformer, so as to monitor height changes in the oil level of the insulating oil during operation. However, a working state or environment of each transformer is not necessarily the same. Even if one standard (e.g., a reference curve that illustrates a variation relationship between the oil level and an oil temperature) can be used to determine a change trend of the oil level in response to oil temperature changes and further determine whether or not an operational state of the transformer is normal, such a standard often fails to reflect an actual height of the oil level. In the relevant industry, the usual process is to first stop the operation of the transformer, and then determine a height of a stabilized oil surface. However, this process is time-consuming and complicated to implement, and in more serious situations, can even result in economic loss due to unstable electricity.

### SUMMARY OF THE DISCLOSURE

In response to the above-referenced technical inadequacies, the present disclosure provides a method and a system for diagnosing leakage of an insulating oil, which are applicable for diagnosis and early warning of an oil leakage anomaly in a transformer.

In order to solve the above-mentioned problems, one of the technical aspects adopted by the present disclosure is to provide a method for diagnosing leakage of an insulating oil. The method is applicable for a transformer, and the transformer includes an oil storage tank and the insulating oil contained in the oil storage tank. The method includes: obtaining state information of the insulating oil within at least one unit time interval, in which the state information includes data of oil temperatures and oil levels at different time points within the at least one unit time interval; establishing a conversion function relationship between the oil temperature and the oil level of the insulating oil based on the state information; and performing, during operation of the transformer, an early leakage warning of the insulating oil according to the conversion function relationship between the oil temperature and the oil level.

In one of the possible or preferred embodiments, the process of performing the early leakage warning of the insulating oil includes: determining whether or not the transformer in operation has an oil leakage anomaly according to the conversion function relationship between the oil temperature and the oil level; and issuing an early warning message when the transformer in operation is determined to have the oil leakage anomaly.

In one of the possible or preferred embodiments, after the process of performing the early leakage warning of the insulating oil, the method further includes: setting an oil level warning value that corresponds to a predetermined oil temperature according to the conversion function relationship between the oil temperature and the oil level; determining whether or not an actual oil level of the insulating oil is less than the oil level warning value when an actual oil temperature of the insulating oil reaches the predetermined oil temperature; and decreasing a load rate of the transformer when the actual oil level of the insulating oil is less than the oil level warning value.

In one of the possible or preferred embodiments, when the transformer in operation is determined to have the oil leakage anomaly, the conversion function relationship between the oil temperature and the oil level is further used in cooperation with the state information for obtaining an oil leakage amount and an oil leakage speed of the insulating oil that are provided as contents of the early warning message.

In one of the possible or preferred embodiments, a quantity of the at least one unit time interval is N, and N is a positive integer greater than 1. The process of establishing the conversion function relationship between the oil temperature and the oil level of the insulating oil includes: obtaining, according to the state information, a relationship curve of the oil temperature and the oil level of the insulating oil within each of the N unit time intervals; and performing a fitting process to generate a standard reference curve that is adapted to the transformer. Furthermore, the process of determining whether or not the transformer in operation has the oil leakage anomaly includes: setting an oil level reference value that corresponds to a predetermined oil temperature according to the standard reference curve; and determining whether or not an actual oil level of the insulating oil is less than the oil level reference value when an actual oil temperature of the insulating oil reaches the predetermined oil temperature, and determining the transformer in operation to have the oil leakage anomaly when the actual oil level of the insulating oil is less than the oil level reference value.

In one of the possible or preferred embodiments, the process of generating the standard reference curve includes: modifying the standard reference curve by a machine learning model that is trained by the state information.

In order to solve the above-mentioned problems, another one of the technical aspects adopted by the present disclosure is to provide a system for diagnosing leakage of an insulating oil. The system is applicable for a transformer, and the transformer includes an oil storage tank and the insulating oil contained in the oil storage tank. The system includes an inspection device and a diagnosis device. The inspection device includes a sensing module and a processing module. The sensing module is disposed on the oil storage tank, and is configured to obtain state information of the insulating oil within at least one unit time interval. The state information includes data of oil temperatures and oil levels at different time points within the at least one unit time interval. The processing module is connected to the sensing module, and is configured to establish a conversion function relationship between the oil temperature and the oil level of the insulating oil based on the state information. The diagnosis device is connected to the processing module, and is configured to perform an early leakage warning of the insulating oil according to the conversion function relationship between the oil temperature and the oil level during operation of the transformer.

In one of the possible or preferred embodiments, according to the conversion function relationship between the oil temperature and the oil level, the diagnosis device determines whether or not the transformer in operation has an oil leakage anomaly, and issues an early warning message when the transformer in operation is determined to have the oil leakage anomaly.

In one of the possible or preferred embodiments, after the diagnosis device performs the early leakage warning of the insulating oil, the diagnosis device sets an oil level warning value that corresponds to a predetermined oil temperature according to the conversion function relationship between the oil temperature and the oil level, determines whether or not an actual oil level of the insulating oil is less than the oil level warning value when an actual oil temperature of the insulating oil reaches the predetermined oil temperature, and notifies a control center to decrease a load rate of the transformer when the actual oil level of the insulating oil is less than the oil level warning value.

In one of the possible or preferred embodiments, when the diagnosis device determines that the transformer in operation has the oil leakage anomaly, the diagnosis device further uses the conversion function relationship between the oil temperature and the oil level in cooperation with the state information for obtaining an oil leakage amount and an oil leakage speed of the insulating oil that are provided as contents of the early warning message.

In one of the possible or preferred embodiments, a quantity of the at least one unit time interval is N, and N is a positive integer greater than 1. According to the state information, the diagnosis device obtains a relationship curve of the oil temperature and the oil level of the insulating oil within each of the N unit time intervals, and converts the relationship curves into a standard reference curve that is adapted to the transformer. When the diagnosis device determines whether or not the transformer in operation has the oil leakage anomaly, the diagnosis device sets an oil level reference value that corresponds to a predetermined oil temperature according to the standard reference curve, determines whether or not an actual oil level of the insulating oil is less than the oil level reference value when an actual oil temperature of the insulating oil reaches the predetermined oil temperature, and determines the transformer in operation to have the oil leakage anomaly when the actual oil level of the insulating oil is less than the oil level reference value.

In one of the possible or preferred embodiments, after generating the standard reference curve, the diagnosis device modifies the standard reference curve by a machine learning model that is trained by the state information.

Therefore, in the method and the system for diagnosing the leakage of the insulating oil provided by the present disclosure, by virtue of “obtaining state information of the insulating oil within at least one unit time interval, in which the state information includes data of oil temperatures and oil levels at different time points within the at least one unit time interval,” “establishing a conversion function relationship between the oil temperature and the oil level of the insulating oil based on the state information,” and “performing, during operation of the transformer, an early leakage warning of the insulating oil according to the conversion function relationship between the oil temperature and the oil level,” each transformer in an electric power system is provided with the most appropriate standard for determining an oil level anomaly, so as to achieve an effect of responding to the leakage of the insulating oil in real time. In this way, anomaly removal time can be effectively reduced, the transformer can be prevented from being damaged, and the occurrence or expansion of damage can be prevented.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for diagnosing leakage of an insulating oil according to the present disclosure;

FIG. 2 is another flowchart of the method for diagnosing the leakage of the insulating oil according to the present disclosure;

FIG. 3 shows relationship curves of an oil temperature and an oil level that are generated in step S2 of the method for diagnosing the leakage of the insulating oil according to the present disclosure;

FIG. 4 is a diagram of an operational framework of a system for diagnosing the leakage of the insulating oil according to the present disclosure;

FIG. 5 is a diagram of another operational framework of the system for diagnosing the leakage of the insulating oil according to the present disclosure; and

FIG. 6 is a schematic view of a partial structure of the system for diagnosing the leakage of the insulating oil according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Furthermore, when one component is described to be “connected” or “coupled” to another component, the two components can be directly connected or coupled, or an intermediate component can exist therebetween.

### Method for Diagnosing Leakage of Insulating Oil

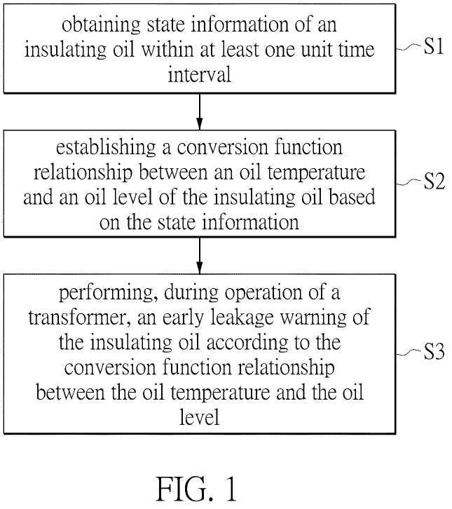

An embodiment of the present disclosure provides a method for diagnosing leakage of an insulating oil, which is applicable for diagnosis and early warning of an oil leakage anomaly in a transformer. Referring to FIG. 1, the method of the present disclosure mainly includes: obtaining state information of the insulating oil within at least one unit time interval (step S1); establishing a conversion function relationship between an oil temperature and an oil level of the insulating oil based on the state information (step S2); and performing, during operation of the transformer, an early leakage warning of the insulating oil according to the conversion function relationship between the oil temperature and the oil level (step S3). Accordingly, differences in operational environments or conditions can be overcome in the present disclosure, and each transformer in an electric power system is provided with the most appropriate standard for determining an oil level anomaly, so as to achieve an effect of responding to the leakage of the insulating oil in real time.

In step S1, the state information of the insulating oil within the at least one unit time interval is obtained when the transformer is running under load. The unit time interval can be one to several hours, a day, a week, or even longer. These examples are provided for illustrative purposes only, and should not be taken as limiting the scope of the present disclosure. Specifically, within each unit time interval, data of a current state of the insulating oil in an oil storage tank is detected once every specified period of time (e.g., every ten minutes or one hour). As such, the state information obtained in step S1 includes data of the oil temperatures and the oil levels at different time points within each unit time interval. Each time point can be a time point after lapse of one or multiple fixed time intervals since a starting time, and the fixed time interval can be freely decided.

In step S2, the state information of the insulating oil is processed and analyzed, and modes and features of such data are integrated to establish a height variation model of the oil level in response to temperature changes. The height variation model is the conversion function relationship between the oil temperature and the oil level, and can be used as the standard for determining whether or not the transformer in operation has the oil leakage anomaly. Specifically, according to the conversion function relationship between the oil temperature and the oil level, whether or not an actual height of the oil level of the insulating oil when reaching a specified oil temperature is low can be determined. If the actual height of the oil level is low, it is determined that the oil leakage has occurred. It is worth mentioning that the conversion function relationship between the oil temperature and the oil level can be used in cooperation with the state information obtained in step S1 for further identification of an oil leakage amount and an oil leakage speed of the insulating oil.

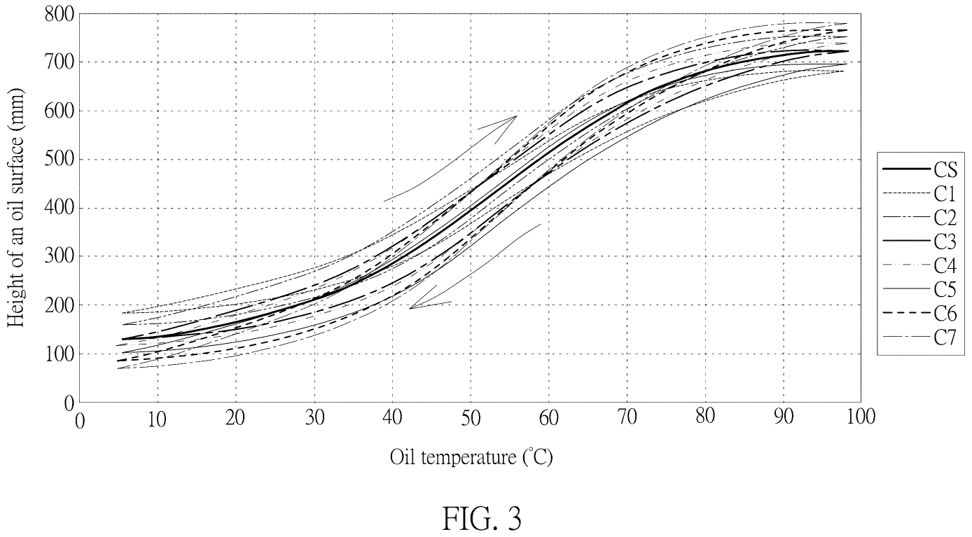

Reference is made to FIG. 3. In one of the feasible embodiments, the state information of the insulating oil within an N number of days is obtained in step S1, where N is a positive integer greater than 1. In addition, the state information of the insulating oil includes the data of the oil temperatures and the oil levels (heights of the oil level under different oil temperatures) within low-temperature to high-temperature times of the day (e.g., from midnight to two o'clock in the afternoon). In step S2, data fitting can be performed on the data obtained by a sensing module, so as to generate a relationship curve of the oil temperature and the height of the oil level within each of the N days. The state information of the insulating oil within seven days is obtained in step S1, and is exemplified for illustrative purposes. In step S2, a relationship curve C1 of the oil temperature and the height of the oil level for a first day, a relationship curve C2 of the oil temperature and the height of the oil level for a second day, a relationship curve C3 of the oil temperature and the height of the oil level for a third day, a relationship curve C4 of the oil temperature and the height of the oil level for a fourth day, a relationship curve C5 of the oil temperature and the height of the oil level for a fifth day, a relationship curve C6 of the oil temperature and the height of the oil level for a sixth day, and a relationship curve C7 of the oil temperature and the height of the oil level for a seventh day are generated.

In step S2, the multiple relationship curves of the oil temperature and the height of the oil level are further converted into a standard reference curve CS that is most adapted to the transformer, so as to act as the standard for determining whether or not the transformer in operation has the oil leakage anomaly. Specifically, an oil level reference value that corresponds to a predetermined oil temperature is set according to the standard reference curve CS, and whether or not an actual oil level of the insulating oil is less than the oil level reference value is determined when an actual oil temperature of the insulating oil reaches the predetermined oil temperature. In the affirmative, the transformer in operation is determined to have the oil leakage anomaly.

In practice, features of the standard reference curve CS are modified by a pre-trained learning model. For example, a curve range, a radius of curvature of a curve, or a slope of the curve is modified. The information for training includes operational environment information (e.g., peripheral environment information) of the transformer, operational state information (e.g., load information) of the transformer, and the state information (e.g., the heights of the oil level that change with temperatures) of the insulating oil.

It should be noted that the standard reference curve CS as shown in FIG. 3 is merely an example and does not cover all possible situations. In response to different transformers, standard reference curves generated in the present disclosure may also vary.

In step S3, whether or not the transformer in operation has the oil leakage anomaly can be determined according to the conversion function relationship between the oil temperature and the oil level that is established in step S2. For this process, reference can be made to the descriptions above. When the transformer is determined to have the oil leakage anomaly, an early warning message is issued. According to practical requirements, contents of the early warning message can include the oil leakage amount and the oil leakage speed of the insulating oil.

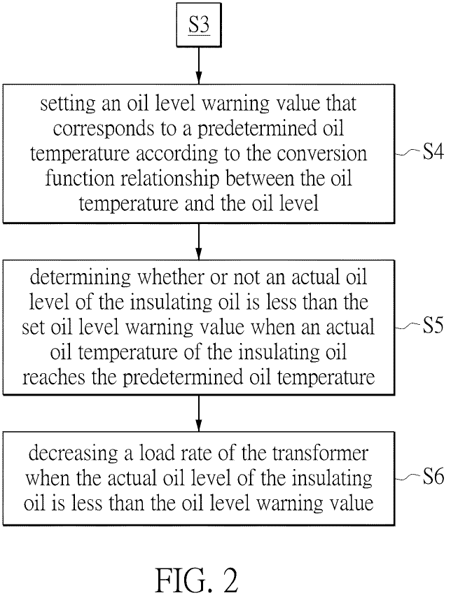

Reference is made to FIG. 2. After step S3, the method of the present disclosure further includes: setting an oil level warning value that corresponds to the predetermined oil temperature according to the conversion function relationship between the oil temperature and the oil level (step S4); determining whether or not the actual oil level of the insulating oil is less than the set oil level warning value when the actual oil temperature of the insulating oil reaches the predetermined oil temperature (step S5 and decreasing a load rate of the transformer when the actual oil level of the insulating oil is less than the oil level warning value (step 6). In this way, malfunctioning of the transformer is preventable, such that stable and safe operations of the electric power system can be maintained.

### System for Diagnosing Leakage of Insulating Oil

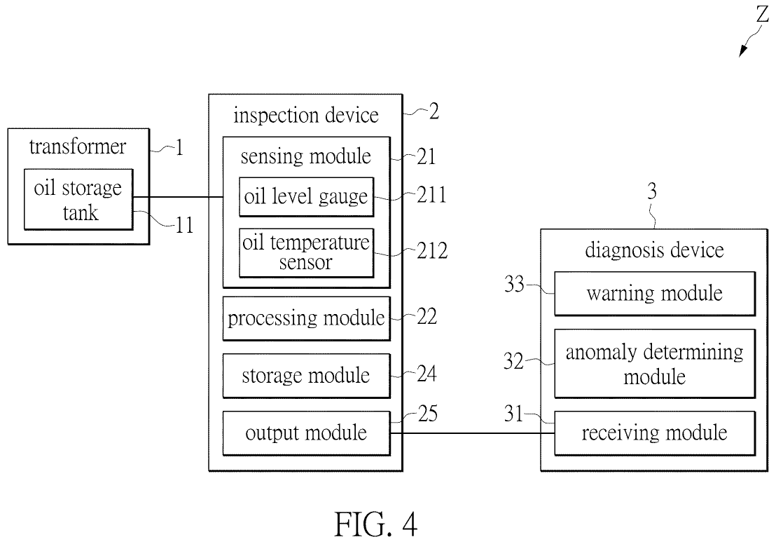

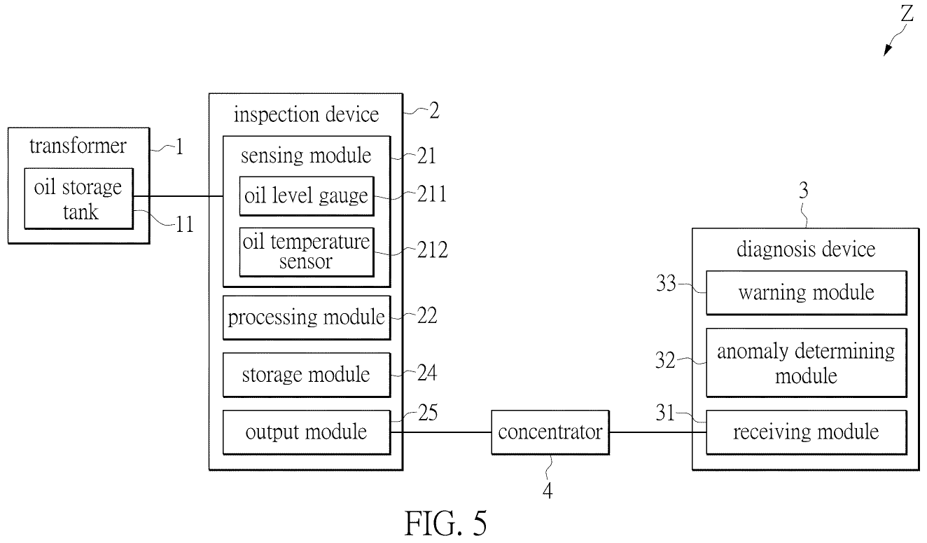

Referring to FIG. 4 and FIG. 5, another embodiment of the present disclosure provides a system Z for implementation of the above-mentioned method. The system Z includes an inspection device 2 and a diagnosis device 3. The inspection device 2 is connected to an oil storage tank 11 of a transformer 1, so as to obtain and analyze state information of an insulating oil. The diagnosis device 3 is connected to the inspection device 2, and diagnosis and early warning of an oil leakage anomaly in the transformer 1 can be performed by analyzing the state information of the insulating oil.

In the present disclosure, the inspection device 2 includes a sensing module 21 and a processing module 22. The sensing module 21 is disposed on the oil storage tank 11. The sensing module 21 is configured to obtain the state information of the insulating oil within at least one unit time interval, and the state information includes data of oil temperatures and oil levels (heights of the oil level under different oil temperatures) at different time points. The processing module 22 is connected to the sensing module 21, and is configured to establish a conversion function relationship between the oil temperature and the oil level of the insulating oil based on the obtained state information. In addition, the diagnosis device 3 is connected to the processing module 22, and is configured to perform an early leakage warning of the insulating oil according to the established conversion function relationship between the oil temperature and the oil level during operation of the transformer 1.

In practice, the inspection device 2 includes a housing 23, and the housing 23 is configured to integrate the sensing module 21, the processing module 22, and the oil storage tank 11 of the transformer 1 into one piece. Specifically, the housing 23 is physically connected to the oil storage tank 11. The processing module 22 is disposed in the housing 23 and electrically connected to the sensing module 21, and can be integrated onto a circuit board. The sensing module 21 can detect state parameters of the insulating oil, such as the oil temperature and the height of the oil level. The processing module 22 can analyze features of these parameters and their underlying critical modes, so as to establish a height variation model of the oil level in response to temperature changes. Here, an nth degree polynomial is used to describe the conversion function relationship between the oil temperature and the oil level. However, the descriptions above are examples for illustrative purposes only, and the present disclosure is not limited thereto.

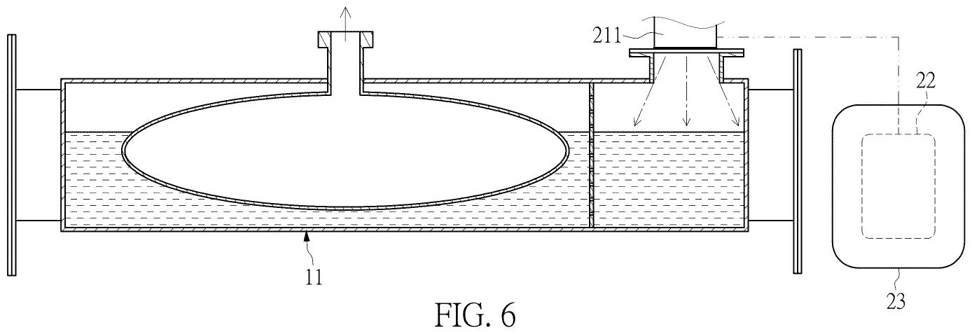

Referring to FIG. 4 and FIG. 5, which are to be read in conjunction with FIG. 6, the sensing module 21 includes an oil level gauge 211 and an oil temperature sensor 212. Through suitable arrangements, the oil level gauge 211 can inspect the height of the oil level of the insulating oil in an optical manner, and the oil temperature sensor 212 (e.g., an infrared temperature sensor) can inspect the oil temperature of a top layer of the insulating oil in a non-contact manner. The processing module 22 can be a processing unit of a microcontroller, or a general-purpose or special-purpose processor, but is not limited thereto. The inspection device 2 further includes a storage module 24 for storing the data obtained by the sensing module 21 and a data-type construction model obtained after the processing module 22 analyzes the data. The storage module 24 can be a storage unit of the microcontroller or a memory in any form, but is not limited thereto.

The diagnosis device 3 includes a receiving module 31, which can be software, hardware, or firmware. As shown in FIG. 4, the receiving module 31 is connected to a wired network, and establishes a communicative connection with the inspection device 2. Alternatively, as shown in FIG. 5, the receiving module 31 is connected to a wireless network, and establishes the communicative connection with the inspection device 2 via a concentrator 4 (e.g., a data centralized unit). Furthermore, the inspection device 2 includes an output module 25, so as to transmit the data and a product analyzed from the data to the receiving module 31. The output module 25 can be a communication module or an output interface, but is not limited thereto.

In practice, the diagnosis device 3 further includes an anomaly determining module 32 and a warning module 33, each of which can be software, hardware, or firmware. According to the conversion function relationship between the oil temperature and the oil level that is established by data analysis, the anomaly determining module 32 determines whether or not the transformer 1 in operation has the oil leakage anomaly. Specifically, according to the conversion function relationship between the oil temperature and the oil level, the anomaly determining module 32 sets an oil level reference value that corresponds to a predetermined oil temperature. When an actual oil temperature of the insulating oil (a current temperature of the insulating oil in the oil storage tank 11) reaches the predetermined oil temperature, whether or not an actual oil level of the insulating oil (a current height of the oil level of the insulating oil in the oil storage tank 11) is less than the oil level reference value is determined. In the affirmative, the transformer 1 in operation is determined to have the oil leakage anomaly. The warning module 33 issues an early warning message when the transformer 1 is determined to have the oil leakage anomaly. By using the conversion function relationship between the oil temperature and the oil level in cooperation with the state information of the insulating oil, the anomaly determining module 32 can further identify an oil leakage amount and an oil leakage speed of the insulating oil that are provided as contents of the early warning message. However, the descriptions above are examples for illustrative purposes only, and the present disclosure is not limited thereto.

The diagnosis device 3 can operate in a networked computer host, but the present disclosure is not limited thereto. During a process of executing a software application, the diagnosis device 3 can inspect and use the data in the inspection device 2. The inspection device 2 may automatically transmit the data to the receiving module 31 via the output module 25. Alternatively, after receipt of an inquiry command transmitted from the receiving module 31, the inspection device 2 transmits the data to the receiving module 31 via the output module 25.

Reference is made to FIG. 3. In one of the feasible embodiments, the sensing module 21 obtains the state information of the insulating oil within an N number of days, where N is a positive integer greater than 1. In addition, the state information of the insulating oil includes the data of the oil temperatures and the oil levels (the heights of the oil level under different oil temperatures) at different time points within a specified time interval of each day. The processing module 22 can perform data fitting on the data obtained by the sensing module 21, so as to generate relationship curves of the oil temperature and the height of the oil level within each of the N days and convert the same into a standard reference curve CS that is most adapted to the transformer 1. In addition, the processing module 22 can set the oil level reference value that corresponds to the predetermined oil temperature according to the standard reference curve CS, and determines whether or not the actual oil level of the insulating oil is less than the oil level reference value when the actual oil temperature of the insulating oil reaches the predetermined oil temperature. In the affirmative, the transformer 1 in operation is determined to have the oil leakage anomaly.

In practice, the diagnosis device 3 can modify features of the standard reference curve CS by a machine learning module that is trained by the state information. For example, a curve range, a radius of curvature of a curve, or a slope of the curve is modified. The information for training includes operational environment information (e.g., peripheral environment information) of the transformer 1, operational state information (e.g., load information) of the transformer 1, and the state information (e.g., the heights of the oil level that change with temperatures) of the insulating oil.

In the present disclosure, the diagnosis device 3 adopts the following control measures to decrease the risk of malfunctioning of the transformer 1. The anomaly determining module 32 sets an oil level warning value that corresponds to the predetermined oil temperature according to the conversion function relationship between the oil temperature and the oil level of the insulating oil (or the standard reference curve CS), and determines whether or not the actual oil level of the insulating oil is less than the oil level warning value when the actual oil temperature of the insulating oil reaches the predetermined oil temperature. Furthermore, when the actual oil level of the insulating oil is less than the oil level warning value, the warning module 33 issues a malfunction warning message, so as to notify a control center to decrease a load rate of the transformer 1.

### Beneficial Effects of the Embodiments

In conclusion, in the method and the system for diagnosing the leakage of the insulating oil provided by the present disclosure, by virtue of “obtaining state information of the insulating oil within at least one unit time interval, in which the state information includes data of oil temperatures and oil levels at different time points within the at least one unit time interval,” “establishing a conversion function relationship between the oil temperature and the oil level of the insulating oil based on the state information,” and “performing, during operation of the transformer, an early leakage warning of the insulating oil according to the conversion function relationship between the oil temperature and the oil level,” each transformer in the electric power system is provided with the most appropriate standard for determining the oil level anomaly, so as to achieve the effect of responding to the leakage of the insulating oil in real time. In this way, anomaly removal time can be effectively reduced, the transformer can be prevented from being damaged, and the occurrence or expansion of damage can be prevented.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for diagnosing leakage of an insulating oil, the method being applicable for a transformer, the transformer including an oil storage tank and the insulating oil contained in the oil storage tank, and the method comprising:
obtaining state information of the insulating oil within at least one unit time interval, wherein the state information includes data of oil temperatures and oil levels at different time points within the at least one unit time interval;
establishing a conversion function relationship between the oil temperature and the oil level of the insulating oil based on the state information; and
performing, during operation of the transformer, an early leakage warning of the insulating oil according to the conversion function relationship between the oil temperature and the oil level.

2. The method according to claim 1, wherein the process of performing the early leakage warning of the insulating oil includes:
determining whether or not the transformer in operation has an oil leakage anomaly according to the conversion function relationship between the oil temperature and the oil level; and
issuing an early warning message when the transformer in operation is determined to have the oil leakage anomaly.

3. The method according to claim 1, wherein, after the process of performing the early leakage warning of the insulating oil, the method further includes:
setting an oil level warning value that corresponds to a predetermined oil temperature according to the conversion function relationship between the oil temperature and the oil level;
determining whether or not an actual oil level of the insulating oil is less than the oil level warning value when an actual oil temperature of the insulating oil reaches the predetermined oil temperature; and
decreasing a load rate of the transformer when the actual oil level of the insulating oil is less than the oil level warning value.

4. The method according to claim 2, wherein, when the transformer in operation is determined to have the oil leakage anomaly, the conversion function relationship between the oil temperature and the oil level is further used in cooperation with the state information for obtaining an oil leakage amount and an oil leakage speed of the insulating oil that are provided as contents of the early warning message.

5. The method according to claim 2, wherein a quantity of the at least one unit time interval is N, and N is a positive integer greater than 1; wherein the process of establishing the conversion function relationship between the oil temperature and the oil level of the insulating oil includes: obtaining, according to the state information, a relationship curve of the oil temperature and the oil level of the insulating oil within each of the N unit time intervals; and converting the relationship curves into a standard reference curve that is adapted to the transformer; and wherein the process of determining whether or not the transformer in operation has the oil leakage anomaly includes:
setting an oil level reference value that corresponds to a predetermined oil temperature according to the standard reference curve; and
determining whether or not an actual oil level of the insulating oil is less than the oil level reference value when an actual oil temperature of the insulating oil reaches the predetermined oil temperature, and determining the transformer in operation to have the oil leakage anomaly when the actual oil level of the insulating oil is less than the oil level reference value.

6. The method according to claim 5, wherein the process of establishing the conversion function relationship between the oil temperature and the oil level of the insulating oil includes: modifying the standard reference curve by a machine learning model that is trained by the state information.

7. A system for diagnosing leakage of an insulating oil, the system being applicable for a transformer, the transformer including an oil storage tank and the insulating oil contained in the oil storage tank, and the system comprising:
an inspection device, wherein the inspection device includes:
a sensing module disposed on the oil storage tank, wherein the sensing module is configured to obtain state information of the insulating oil within at least one unit time interval, and the state information includes data of oil temperatures and oil levels at different time points within the at least one unit time interval; and
a processing module connected to the sensing module, wherein the processing module is configured to establish a conversion function relationship between the oil temperature and the oil level of the insulating oil based on the state information; and
a diagnosis device connected to the processing module, wherein the diagnosis device is configured to perform an early leakage warning of the insulating oil according to the conversion function relationship between the oil temperature and the oil level during operation of the transformer.

8. The system according to claim 7, wherein, according to the conversion function relationship between the oil temperature and the oil level, the diagnosis device determines whether or not the transformer in operation has an oil leakage anomaly, and issues an early warning message when the transformer in operation is determined to have the oil leakage anomaly.

9. The system according to claim 8, wherein, after the diagnosis device performs the early leakage warning of the insulating oil, the diagnosis device sets an oil level warning value that corresponds to a predetermined oil temperature according to the conversion function relationship between the oil temperature and the oil level, determines whether or not an actual oil level of the insulating oil is less than the oil level warning value when an actual oil temperature of the insulating oil reaches the predetermined oil temperature, and notifies a control center to decrease a load rate of the transformer when the actual oil level of the insulating oil is less than the oil level warning value.

10. The system according to claim 8, wherein, when the diagnosis device determines that the transformer in operation has the oil leakage anomaly, the diagnosis device further uses the conversion function relationship between the oil temperature and the oil level in cooperation with the state information for obtaining an oil leakage amount and an oil leakage speed of the insulating oil that are provided as contents of the early warning message.

11. The system according to claim 8, wherein a quantity of the at least one unit time interval is N, and N is a positive integer greater than 1; wherein, according to the state information, the diagnosis device obtains a relationship curve of the oil temperature and the oil level of the insulating oil within each of the N unit time intervals, and converts the relationship curves into a standard reference curve that is adapted to the transformer; and
wherein, when the diagnosis device determines whether or not the transformer in operation has the oil leakage anomaly, the diagnosis device sets an oil level reference value that corresponds to a predetermined oil temperature according to the standard reference curve, determines whether or not an actual oil level of the insulating oil is less than the oil level reference value when an actual oil temperature of the insulating oil reaches the predetermined oil temperature, and determines the transformer in operation to have the oil leakage anomaly when the actual oil level of the insulating oil is less than the oil level reference value.

12. The system according to claim 11, wherein, after generating the standard reference curve, the diagnosis device modifies the standard reference curve by a machine learning model that is trained by the state information.
